(19) United States
(12) Patent Application Publication
(10) Pub. No.: US 2025/0141827 A1
(43) Pub. Date: May 1, 2025

(54) METHOD FOR PROCESSING MESSAGE OF ELECTRONIC DEVICE AND SERVER DEVICE

(71) Applicant: SAMSUNG ELECTRONICS CO., LTD., Suwon-si (KR)

(72) Inventors: Kyujin HAN, Suwon-si (KR); Juho Kim, Suwon-si (KR); Minsun Kim, Suwon-si (KR)

(73) Assignee: SAMSUNG ELECTRONICS CO., LTD., Suwon-si (KR)

(21) Appl. No.: 18/952,497

(22) Filed: Nov. 19, 2024

Related U.S. Application Data
(63) Continuation of application No. PCT/KR2024/015223, filed on Oct. 7, 2024.

(30) Foreign Application Priority Data
Oct. 26, 2023 (KR) 10/2023-0144637
Nov. 22, 2023 (KR) 10-2023-0163172

(51) Int. Cl. H04L 51/56; H04L 51/216; H04L 51/58; H04W 4/14

(52) U.S. Cl. CPC H04L 51/56; H04L 51/216; H04L 51/58; H04W 4/14

(57) ABSTRACT

A server may include a communication interface, a memory, and a processor operatively connected to the communication interface and the memory. The processor may receive data related to a group SMS of a group comprising a first electronic device; receive a plurality of messages transmitted by the first electronic device from a SMS message center (SMSC); perform forking on the plurality of messages sequentially; generate an object corresponding to the group SMS based on address information of forked messages that match the data related to the group SMS received from the first electronic device; and transmit the object corresponding to the group SMS to a second electronic device.

### CROSS-REFERENCES TO RELATED APPLICATIONS

This application is a continuation of International Application No. PCT/KR2024/015223, filed with the Korean Intellectual Property Office on Oct. 7, 2024, which claims priority from Korean Patent Application No. 10-2023-0144637, filed on Oct. 26, 2023, and Korean Patent Application No. 10-2023-0163172, filed on Nov. 22, 2023, in the Korean Intellectual Property Office, the disclosures of which are incorporated by reference herein in their entireties.

### BACKGROUND

### 1. Field

Various embodiments of the disclosure relate to an electronic device and a server device, for example, an electronic device capable of transmitting and receiving messages written by a user and a server device capable of transmitting, receiving, and storing messages transmitted and received from various electronic devices.

### 2. Description of Related Art

With the development of mobile communication technology, portable electronic devices (hereinafter, referred to as electronic devices) may provide user experience through various data communication functions. The electronic device may provide message services such as a short message service (SMS) or a multimedia message service (MMS) that can transmit a message written by a user to a counterpart, and recently a message service based on a rich communication service (RCS) that can replace the legacy service such as the SMS or the MMS is provided.

The RCS is the standard of message services through cellular wireless communication and includes a communication protocol based on an Internet protocol multimedia subsystem (IMS). Compared to the legacy service such as the SMS or the MMS, the RCS has various advantages of increasing a message length, providing a read receipt function, or easily interworking with another application and thus is being widely used. Further, the RCS may provide a group SMS in which a plurality of users can participate in real time, and also provide transmission of a large file.

When the electronic device uses the group SMS based on the RCS, a platform (or operating system) of the electronic device is required to support the RCS, but a device that does not support the RCS may be required to synchronize group SMS information. For example, a user of the electronic device may desire to identify group SMS information through another device (for example, a laptop PC) that does not support the RCS. To this end, group SMS synchronization by a message store server may be provided in the network. The message store server may interwork with an RCS server and provide group SMS information to the device that does not support the RCS.

### SUMMARY

A server according to this document may include a communication interface, memory, and a processor operatively connected to the communication interface and the memory. The processor may receive data related to a group SMS of a group comprising a first electronic device; receive a plurality of messages transmitted by the first electronic device from a SMS message center (SMSC); perform forking on the plurality of messages sequentially; generate an object corresponding to the group SMS based on address information of forked messages that match the data related to the group SMS received from the first electronic device; and transmit the object corresponding to the group SMS to a second electronic device.

A server according to this document may include a communication interface, memory, and a processor operatively connected to the communication interface and the memory. The processor may receive data related to a group SMS of a group comprising a first electronic device; receive a plurality of messages transmitted by the first electronic device from a SMS message center (SMSC); sequentially perform forking on the plurality of messages; transmit a first notification for forked messages to the first electronic device; and transmit a second notification for the group SMS to a second electronic device based on information indicating that the forked messages are included in the group SMS is received from the first electronic device.

A method of operating a server according to this document may include receiving data related to a group SMS of a group comprising a first electronic device; receiving a plurality of messages transmitted by the first electronic device from a SMS message center (SMSC); sequentially performing forking on the plurality of messages; generating a first object corresponding to the group SMS based on address information of forked messages that matches the data related to the group SMS received from the first electronic device; and transmitting the first object corresponding to the group SMS to a second electronic device.

### BRIEF DESCRIPTION OF THE DRAWINGS

FIG. 1 is a block diagram of an electronic device within a network environment according to various embodiments.

FIG. 2 is a block diagram of a message transmission and reception system according to an embodiment.

FIG. 3A is a diagram illustrating an operation diagram when a message is transmitted by a primary device (PD) in the message transmission and reception system according to an embodiment.

FIG. 3B is a diagram illustrating an operation diagram when a message is transmitted by a secondary device (SD) in the message transmission and reception system according to an embodiment.

FIG. 4 illustrates a UI of a group SMS displayed in a first electronic device (PD) and a second electronic device (SD) according to an embodiment.

FIG. 5 illustrates a UI of a group SMS displayed in a second electronic device (SD) according to an embodiment.

FIG. 6 illustrates a UI of the group SMS is synchronized in the first electronic device (PD) and the second electronic device (SD) according to an embodiment.

FIG. 7 illustrates an exemplary form of a SMS object including information on a plurality of recipients according to an embodiment.

FIG. 8 is a block diagram of a server device according to an embodiment.

FIG. 9 is a block diagram of an electronic device according to an embodiment.

FIG. 10 illustrates a workflow diagram when information on a group SMS is shared between electronic devices before the group SMS is transmitted according to an embodiment.

FIG. 11 illustrates a workflow diagram when an electronic device updates a flag of a SMS object and shares information on the group SMS according to an embodiment.

FIG. 12 illustrates workflow diagram of transmitting the group SMS through an external server according to an embodiment.

FIG. 13 is a flowchart illustrating a method by which the electronic device processes a message according to an embodiment.

### DETAILED DESCRIPTION

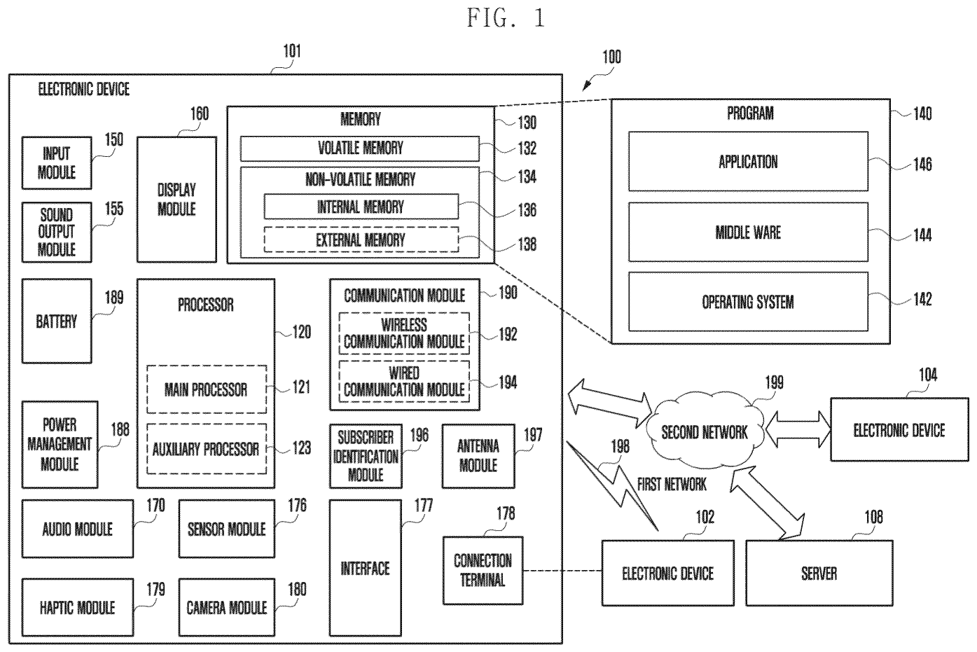

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high- frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

A first electronic device (PD) may display a user interface (UI) that transmits messages to a plurality of recipients at once. In this case, the first electronic device (PD) may gather and display the plurality of recipients on the UI. However, when actually transmitting a message, the first electronic device (PD) may operate to transmit SMSs one by one to individual recipients. The first electronic device (PD) may gather and display the plurality of recipients on the UI, but a second electronic device (SD) may recognize that respective SMSs are transmitted one by one to individual recipients.

Accordingly, the first electronic device (PD) may display one group chat window, but the second electronic device (SD) may display a plurality of chat windows. Therefore, a user transmitting a group SMS by using the first electronic device (PD) may have difficulty in transmitting an additional group SMS by using the second electronic device (SD) because UIs thereof are different.

According to an embodiment, an electronic device (for example, a first electronic device (PD)) may synchronize a UI for a group SMS with an auxiliary electronic device (for example, a second electronic device (SD)) to improve the usability and user experience.

The technical subjects pursued in the disclosure are not limited to the above mentioned technical subjects, and other technical subjects which are not mentioned may be clearly understood through the following descriptions by those skilled in the art of the disclosure.

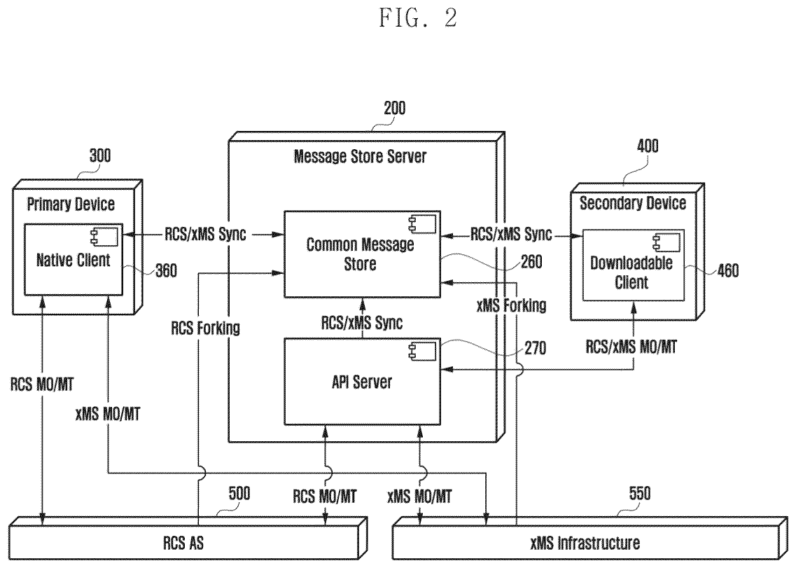

FIG. 2 is a block diagram illustrating a message transmission and reception system according to an embodiment.

Referring to FIG. 2, the message transmission and reception system may include a primary device 300, a secondary device 400, a message store server 200, a rich communication services application server (RCS AS) 500, and an xMS infrastructure 550. Respective devices may be connected to each other through the network.

According to an embodiment, the primary device 300 and the secondary device 400 may be various types of electronic devices (for example, the electronic device 101 of FIG. 1) used by the user. For example, the primary device 300 and the secondary device 400 may be implemented as portable communication devices (for example, smartphones or tablet PCs), computing devices (for example, desktop PCs or laptop PCs), or wearable devices (for example, smart watches or head-mounted devices), but are not limited thereto. Hereinafter, both the primary device 300 and the secondary device 400 may be referred to as electronic devices. In FIG. 2, the primary device 300 and the secondary device 400 are devices of the same user, and may use the same or linked identification information (for example, IMEI or account) and thus may be recognized as devices of the same user in the network.

According to an embodiment, the primary device 300 may be a device including a native client 360 supporting a rich communication service (RCS). The native client 360 is a native version of an application supporting the RCS and may be installed when the primary device 300 is manufactured and/or firmware of the primary device 300 is updated. The primary device 300 may implement a basic message application as the RCS.

According to an embodiment, the secondary device 400 may include a downloadable client 460 supporting the RCS. In embodiments, secondary device may not include the native client 360. For example, a platform (or an operating system) of the secondary device 400 may not basically support the RCS, and the user may download the downloadable client 460 from an application market, and install and execute the same. According to an embodiment, a plurality of secondary devices corresponding to one primary device 300 may be used.

In this document, the native client 360 may be an entity that transmits and receives real messages through RCS AS 500 or xMS infrastructure 550. The downloadable client 460 may synchronize transmitted and received messages through the native client 360, store the same, and provide the same to the user. The downloadable client 460 may also transmit the messages through the message store server 200.

According to an embodiment, the RCS AS 500 may be an application server that handles transmission and reception of a RCS message of global system for the mobile communications association (GSMA) standard. The RCS AS 500 may provide various RCS functions such as user registration and authentication related to the RCS, message routing, a group SMS, and/or file transmission.

According to an embodiment, the xMS infrastructure 550 may be an infrastructure that handles transmission and reception of a legacy message, such as one of the 3GPP standard. In this document, legacy message services before the RCS such as a short message service (SMS), a multimedia message service (MMS), or a long message service (LMS) may be referred to as an xMS.

According to an embodiment, a RCS message transmitted and received (or RCS mobile originated (MO)/mobile terminated (MT)) by the native client 360 of the primary device 300 may be transmitted and received to and from another mobile terminal (or a counterpart device) through the RCS AS. The transmitted and received xMS message (or xMS MO/MT) may be transmitted and received to and from another mobile terminal through the xMS infrastructure 550. The downloadable client 460 of the secondary device 400 may not directly access the RCS AS 500 and the xMS infrastructure 550. The RCS message or the xMS message transmitted and received by the secondary device 400 may be transmitted and received to and from another mobile terminal through the message store server 200 (for example, an application programming server (API) server 270).

According to an embodiment, the message store server 200 may be a server that provides an open mobile alliance converged IP messaging (OMA CPM) service environment. The message store server 200 may perform various operations such as routing and storing data related to the RCS message and/or the xMS message. The message store server 200 may provide the downloadable client 450 with the message transmitted and received by the native client 360. Further, the message store server 200 may transmit the message transmitted by the downloadable client 460 through a real message server.

According to an embodiment, the message store server 200 may include a common message store 260 and the application programming interface (API) server 270. The common message store 260 may store a message transmitted and received by each electronic device (for example, the primary device 300 or the secondary device 400) via the message store server 200. The API server 270 may transmit the RCS message of which transmission was requested by the downloadable client 460 to another mobile terminal via the RCS AS 500. The API server 270 may also transmit the xMS message of which transmission was requested to another mobile terminal via the xMS infrastructure 550.

According to an embodiment, when the native client 360 of the primary device 300 transmits the RCS message to another mobile terminal, the RCS message may be transmitted to the RCS AS 500. The RCS AS 500 may fork the RCS message to the common message store 260 of the message store server 200. The forking may be an operation of simultaneously transmitting a specific message or data to several destinations through one transmission request. The message store server 200 may synchronize the RCS message forked to the common message store 260 with the downloadable client 460 of the secondary device 400. When the native client 360 transmits the xMS message to another mobile terminal, the xMS message may be transmitted to the xMS infrastructure 550. The xMS infrastructure 550 may fork the xMS message to the common message store 260 of the message store server 200. The message store server 200 may synchronize the xMS message forked to the common message store 260 with the downloadable client 460 of the secondary device 400.

According to an embodiment, when the downloadable client 460 of the secondary device 400 transmits the RCS message or the xMS message to another mobile terminal, the RCS message or the xMS message may be transmitted to the API server 270 of the message store server 200. The API server 270 may store the received RCS message or xMS message and synchronize the stored RCS message or xMS message with the common message store 260. The message store server 200 may synchronize the RCS message or xMS message synchronized and stored in the common message store 260 with the native client 360 of the primary device 300.

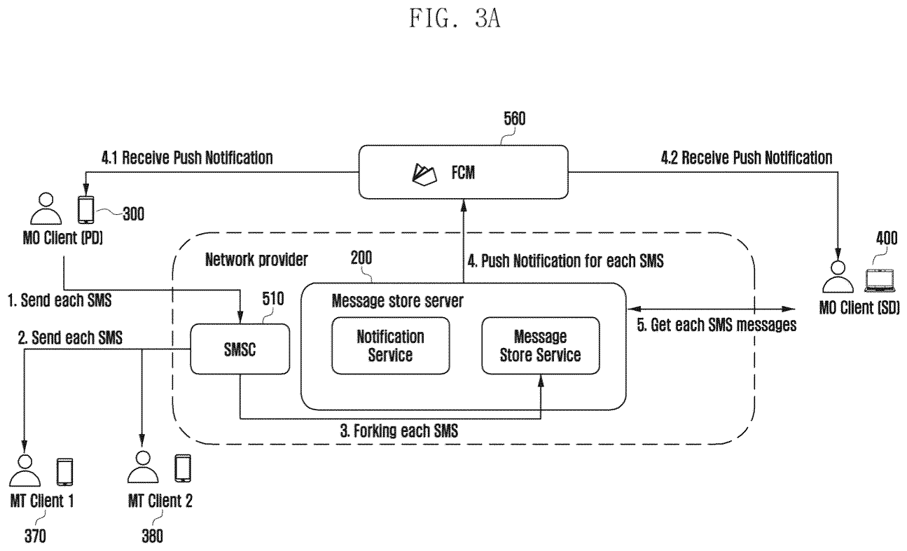

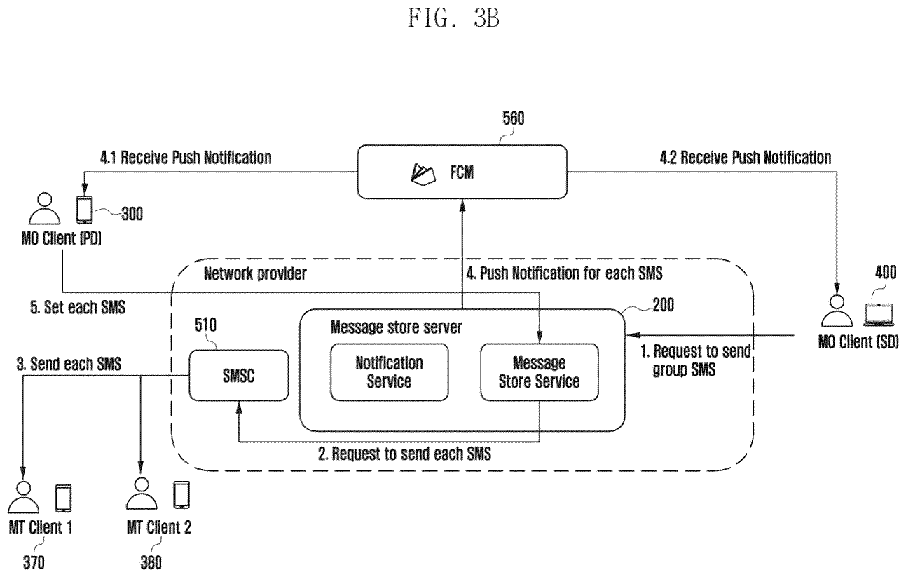

FIG. 3A illustrates an operation of each entity when a message is transmitted by a primary device (PD) in a message transmission and reception system according to an embodiment. In FIG. 3A, a primary device (PD) 300 is a device including a native client (for example, the native client 360 of FIG. 2), and a message of which transmission is requested by the user may be transmitted to the network through the native client. A secondary device (SD) 400 is a device including a downloadable client (for example, the downloadable client 460 of FIG. 2) and may access the network through an account of the same user as that of the primary device 300. A group SMS based on rich communication services (RCS) may be provided using the primary device 300, in which at least one other mobile terminal (MT1 370 and MT2 380) including RCS native clients may participates.

According to an embodiment, the message store server 200 may perform various operations such as routing and storing data related to the RCS message. For example, the message store server 200 may perform various operations for synchronizing a message transmitted and received by the primary device 300 with the secondary device 400. The message store server 200 may communicate with an authentication server that performs authentication of a user (for example, a sender or a recipient) and an account server that manages user account information.

According to an embodiment, the primary device 300 may generate a message to be transmitted in the group SMS, based on a user input. The primary device 300 may transmit the generated group SMS message to a SMS center (SMSC) 510. The native client of the primary device 300 may transmit the group SMS message by using a RCS scheme.

According to an embodiment, the SMSC 510 may transmit the group SMS message transmitted from the primary device 300 to another mobile terminal (MT1 370 or MT2 380). An interface between the SMSC 510 and the primary device 300 or another mobile terminal (MT1 370 or MT2 380) may be considered as a RCS interface, and the primary device 300 and another mobile terminal (MT1 370 or MT2 380) may access the SMSC 510 with a RCS account.

According to an embodiment, the SMSC 510 may transfer the group SMS message transmitted from the primary device 300 to the message store server 200. For example, the SMSC 510 may fork the group SMS RCS message to a common message store (for example, the common message store 260 of FIG. 2) of the message store server 200.

According to an embodiment, the message store server 200 may identify the connected client in the received group SMS message. For example, the message store server 200 may identify at least one client (for example, the native client and/or the downloadable client) that accesses with a sender's account or a recipient's account by using account information of participants in the group SMS through communication with the account server.

According to an embodiment, the message store server 200 may transmit a push message (or a push notification) to a push server 560 (referred to sometimes as FCM) to transmit the push message (or the push notification) to a device of the identified client. In this case, the message store server 200 may provide information (for example, an account, an IMEI, and/or an IP address) on the recipient of the push message to the push server, and the push server may transmit the push message to the client of the recipient. For example, the message store server 200 may transmit the push message to the primary device 300 including the client that accesses with the account of the sender of the group SMS message, and the secondary device 400 through the push server. The push message may include information such as an ID of the group SMS, a sender, and/or a path (for example, a URL) along which the message can be acquired.

According to an embodiment, when receiving the push message, the primary device 300 may identify that the push message is relevant to the group SMS message which the primary device itself transmitted. Since a reason for update occurs due to the group SMS message transmitted by the primary device itself, the primary device 300 may not perform a separate operation in response to reception of the push message.

According to an embodiment, when receiving the push message, the secondary device 400 may identify the group SMS message in the message store server 200 by using information included in the push message. For example, the push message may include URL information from which the group SMS message can be acquired, and the secondary device 400 may access the message store server 200 by using the corresponding URL information to acquire the group SMS message.

According to an embodiment, the secondary device 400 may store the acquired group SMS message and update a UI of the message application.

The primary device 300 may transmit a message having the same content to a plurality of recipients. The primary device 300 may display a user interface (UI) that transmits messages to a plurality of recipients at once. In this case, the primary device 300 may gather and display the plurality of recipients on the UI. However, when actually transmitting the message, the primary device 300 may operate to transmit SMSs one by one to individual recipients.

The primary device 300 gathers and displays the plurality of recipients on the UI, but the secondary device 400 may recognize that one SMS is transmitted to an individual recipient and thus an address of the individual recipient may be separately displayed. Accordingly, the primary device 300 displays one group chat window, but the secondary device 400 may display a plurality of chat windows. In this case, the user transmitting the group SMS by using the primary device 300 may have difficulty in transmitting an additional group SMS by using the secondary device 400 because UIs thereof are different.

FIG. 3B illustrates an operation of each entity when a message is transmitted by the secondary device (SD) in the message transmission and reception system according to an embodiment.

According to an embodiment, the secondary device 400 may make a request for transmitting a group SMS message to the message store server 200. In this case, the message store server 200 may transmit the SMS to each recipient of the group SMS message by using the SMS center (SMSC) 510. The SMS center (SMSC) 510 may fork each SMS to the message store server 200. The forking may be an operation of simultaneously transmitting a specific message or data to several destinations through one transmission request.

The message store server 200 may generate an object corresponding to each SMS and transmit pushes for respective SMSs to the primary device 300 by using the push server 560. The primary device 300 may receive the pushes for respective SMSs and display an individual SMS.

The secondary device 400 may gather and display a plurality of recipients of the group SMS on the UE, and display one group chat window. However, since the primary device 300 receives each push and individually display the SMSs, a plurality of chat windows may be displayed. In this case, the user transmitting the group SMS by using the secondary device 400 may have difficulty in transmitting an additional group SMS by using the primary device 300 because UIs thereof are different.

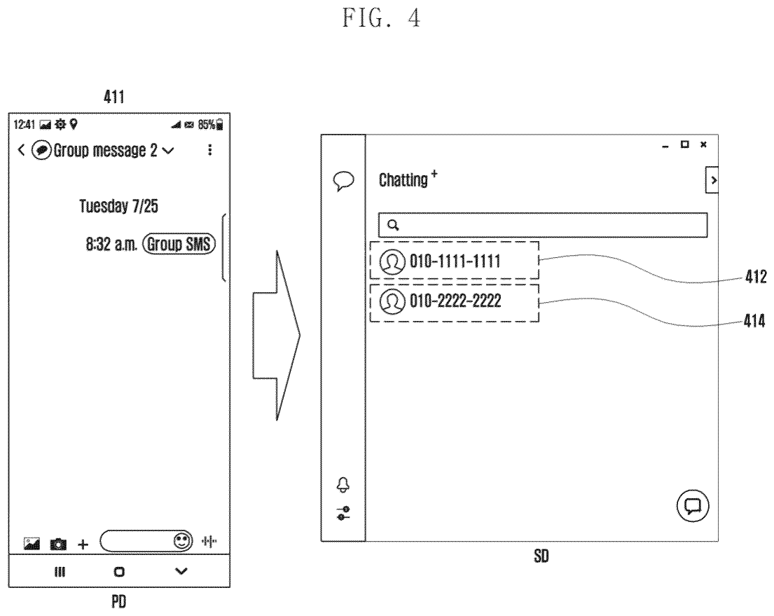

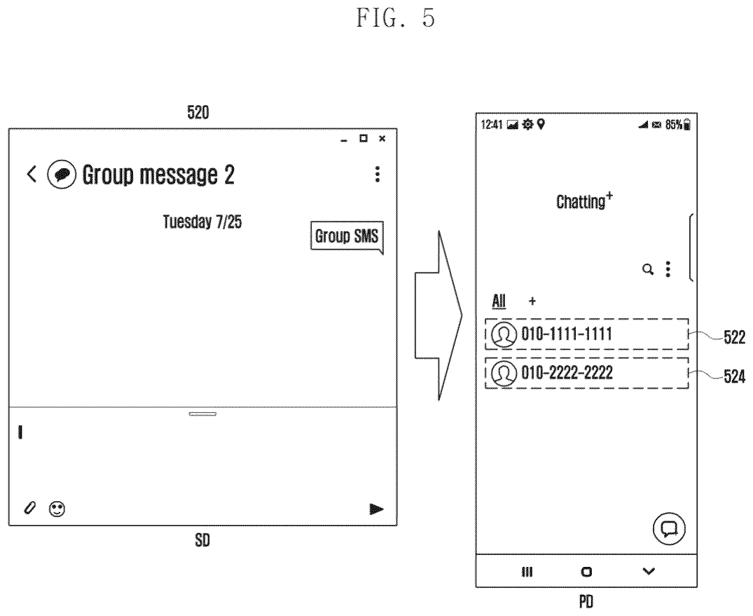

FIGS. 4 and 5 illustrate embodiments in which a UI of a group SMS is displayed in a first electronic device (PD) and a second electronic device (SD) according to an embodiment.

As indicated by diagram 411 of FIG. 4, the first electronic device (PD) may transmit a message having the same content to a plurality of recipients. The first electronic device (PD) may display a user interface (UI) that transmits messages to the plurality of recipients at once. In this case, the first electronic device (PD) may gather and display the plurality of recipients on the UI. However, when actually transmitting the message, the first electronic device (PD) may operate to transmit SMSs one by one to individual recipients.

The first electronic device (PD) gathers and displays the plurality of recipients on the UE, but the second electronic device (SD) may recognize that one SMS is transmitted to the individual recipient and display each of addresses 412 and 414 of the individual recipients. Accordingly, the first electronic device (PD) displays one group chat window, but the second electronic device (SD) may display a plurality of chat windows. In this case, the user transmitting the group SMS by using the first electronic device (PD) may have difficulty in transmitting an additional group SMS by using the second electronic device (SD) because UIs thereof are different.

As indicated by diagram 520 of FIG. 5, the second electronic device (SD) may transmit a message having the same content to a plurality of recipients. The second electronic device (SD) may display a user interface (UI) that transmits messages to the plurality of recipients at once. In this case, the second electronic device (SD) may gather and display the plurality of recipients on the UI. However, when actually transmitting the message, the second electronic device (SD) may operate to transmit SMSs one by one to individual recipients.

The second electronic device (SD) gathers and displays the plurality of recipients on the UI, but the first electronic device (PD) may recognize that one SMS is transmitted to the individual recipient and display each of addresses 522 and 524 of individual recipients. Accordingly, the second electronic device (SD) displays one group chat window, but the first electronic device (PD) may display a plurality of chat windows. In this case, the user transmitting the group SMS by using the second electronic device (SD) may have difficulty in transmitting an additional group SMS by using the first electronic device (PD) because UIs thereof are different.

The electronic device (for example, the electronic device 101 of FIG. 1) according to this document may synchronize the UI for the group SMS with the auxiliary device (for example, the second electronic device (SD)), so as to improve the usability.

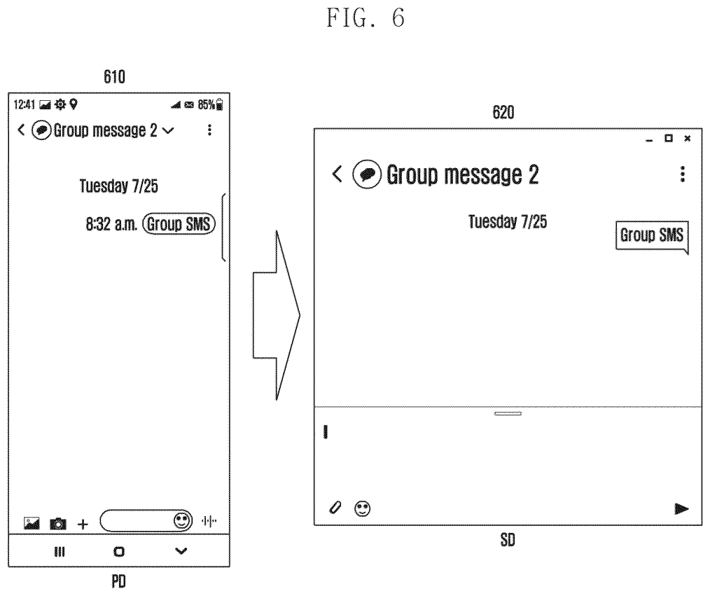

FIG. 6 illustrates an embodiment of synchronizing a UI Of a group SMS in a first electronic device (PD) and a second electronic device (SD) according to an embodiment.

As indicated by diagram 610 of FIG. 6, the first electronic device (PD) may transmit a message having the same content to a plurality of recipients. The first electronic device (PD) may display a user interface (UI) that transmits messages to the plurality of recipients at once.

As indicated by diagram 620 of FIG. 6, the second electronic device (SD) may recognize whether the first electronic device (PD) transmits a group SMS and, similar to the first electronic device (PD), display a user interface (UI) that transmits messages to a plurality of recipients at once.

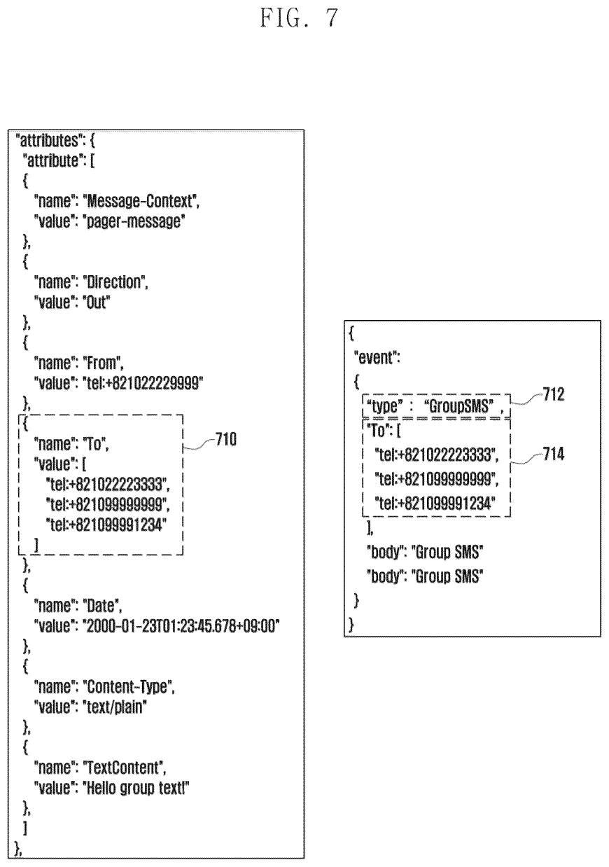

FIG. 7 illustrates the form of a SMS object including information on a plurality of recipients according to an embodiment.

Referring to FIG. 7, an object related to messages exchanged within a group SMS room may be generated. The object may include a new form in which the group SMS (SMS) can be processed. The object may be an object related to messages of a legacy message service (or xMS). The object is a basic object defined in the CPM and may include a multipurpose Internet mail extensions (MIME) object including header attributes (or metadata) such as a content type for identifying a message type and format. The message object may include information on messages actually exchanged between clients. For example, the message object may include sender and recipient information, time information, a subject, a conversation ID, a contribution ID, a P-Asserted-service, an IMDN-message-ID, or a content type.

According to an embodiment, the object may include information 712 on “type” indicating the group SMS (SMS). Further, the object may include information 714 on a plurality of recipients. A processor (for example, the processor 120 of FIG. 1) may control the second electronic device (SD) to display a UI related to the group SMS, based on the information 714 on the plurality of recipients included in the object.

When one message object includes the information 714 on the plurality of recipients or the information 712 on “type” indicating the group SMS, the processor 120 may store the object in a database in the form of a group SMS (SMS) having one group ID.

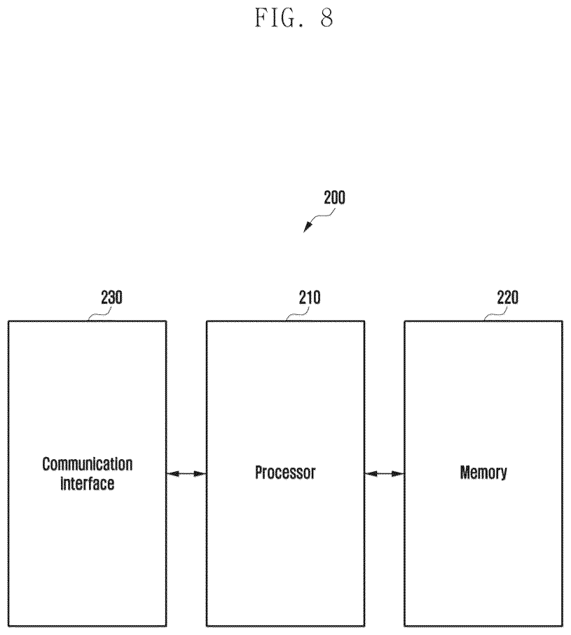

FIG. 8 is a block diagram of a server device according to an embodiment.

Referring to FIG. 8, the server device 800 according to an embodiment may include a communication interface 230, a processor 210, and a memory 220. Although some of the illustrated components are omitted or replaced, various embodiments of this document can be implemented. At least some of the components of the server device 200 which are (or are not) illustrated may be operatively, functionally, and/or electrically connected.

According to an embodiment, the server device 200 may be a message store server (for example, the message store server 200 of FIGS. 2 to 4) that provides an open mobile alliance converged IP messaging (OMA CPM) service environment.

According to an embodiment, the communication interface 230 may support communication with various electronic devices through the network. The communication interface 230 may provide various interfaces such as a hypertext transfer protocol (HTTP), representational state transfer (REST), message queuing telemetry transport (MQTT), or a socket. The server device 200 may communicate with clients (for example, the primary device 300 and the secondary device 400 of FIG. 2) and/or servers (for example, the RCS AS 500 and the push server 560 of FIG. 2) in the network through the communication interface 230.

According to an embodiment, the memory 220 may transitorily or non-transitorily various pieces of data. The memory 220 may include various types of memory 220 such as random access memory (RAM), virtual memory, cache memory, and/or flash memory.

According to an embodiment, the processor 210 is a component capable of performing calculations for control and/or communication of each component of the server device 200 or data processing and may be constituted by or may comprise one or more processors. There is no limitation in calculations and data processing functions that can be implemented in the server device 200 by the processor 210 but, hereinafter, various embodiments for allowing electronic devices (for example, a primary device and a secondary device) to synchronize an event occurring in a group SMS are described. Operations of the processor 210 described below may be performed as instructions stored in the memory 220 are loaded.

According to an embodiment, the processor 210 may identify that a group SMS of a group including a first electronic device (or a primary device) is initiated. The group SMS may be a group SMS capable of transmitting and receiving messages between a plurality of participants, based on a rich communication service (RCS). The first electronic device may be a primary device (for example, the primary device of FIGS. 2 to 4) including a native client. For example, the native client is a native version of an application supporting the RCS and may be installed when the primary device is manufactured and/or firmware is updated. The first electronic device may implement a basic message application by the RCS.

According to an embodiment, a user of the first electronic device may use a group SMS through a second electronic device by using the same account. The second electronic device may be a secondary device (for example, the secondary device of FIGS. 2 to 4) that does not include the native client and includes a downloadable client supporting the RCS. The second electronic device may operate with a platform (or operating system) different from the first electronic device.

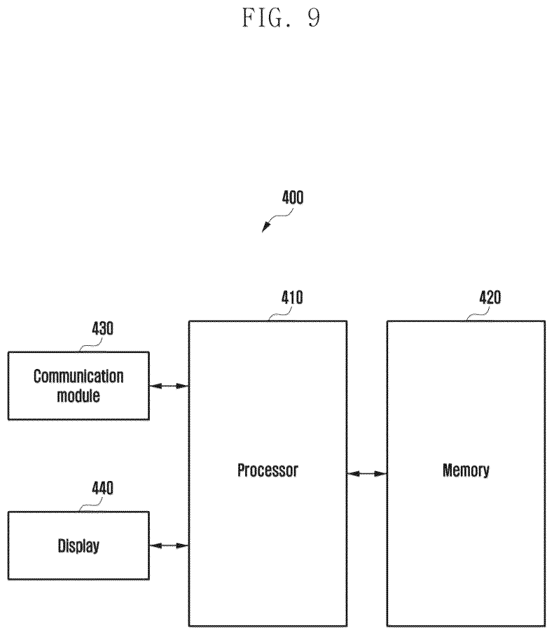

FIG. 9 is a block diagram of an electronic device according to an embodiment.

Referring to FIG. 9, the electronic device 400 according to an embodiment may include a display 440, a communication module 430, a processor 410, and a memory 420. Although some of the illustrated components are omitted or replaced with other components, various embodiments of this document can be implemented. The electronic device 400 may further include at least some of the components and/or functions of the electronic device 101 of FIG. 1 as well as the illustrated components. At least some of the elements of the electronic device 400 which are (or are not) illustrated may be operatively, functionally, and/or electrically connected.

According to an embodiment, the electronic device 400 may be the secondary device 400 of FIGS. 2 to 4. For example, the electronic device 400 may not include a native client but may include a downloadable client supporting the RCS. For example, a platform (or an operating system) of the secondary device may not basically support the RCS, and the user may download the downloadable client supporting the RCS from an application market, and install and execute the same. The electronic device 400 may acquire information related to a group SMS through a message server (for example, the message store server 200 of FIGS. 2 to 4 or the server device 200 of FIG. 9).

According to an embodiment, the electronic device 400 is a device of the same user as that of another electronic device (for example, the primary device 300 of FIGS. 2 to 4) and may access a group SMS service through the same account. For example, when another electronic device participates in the group SMS and transmits a message, the electronic device 400 may acquire corresponding event information from the message server and update the group SMS information.

According to various embodiments, the display 440 may be implemented as one of a liquid crystal display (LCD), a light-emitting diode (LED) display, or an organic light-emitting diode (OLED) display, but is not limited thereto. The display 440 may be a touch screen that detects a touch and/or a proximity touch (or hovering) input using a user's body part (for example, a finger) or an input device (for example, a stylus pen). The display 440 may include at least some of the components and/or functions of the display module 160 of FIG. 1.

According to an embodiment, the communication module 430 may include various hardware and/or software components for supporting wireless communication with an external device (for example, the server device 200 of FIG. 8). The communication module 430 may support short-range wireless communication (for example, Wi-Fi or Bluetooth) and cellular wireless communication (for example, 4G LTE or 5G NR). The communication module 430 may include at least some of the components and/or functions of the communication module 190 of FIG. 1.

According to an embodiment, the memory 420 includes volatile memory and nonvolatile memory and may temporarily or permanently store various pieces of data. The memory 420 includes at least some of the components and/or functions of the memory 130 of FIG. 1, and may store at least some of the programs 140 of FIG. 1.

According to various embodiments, the memory 420 may store various instructions that can be executed by the processor 410. The instructions may include arithmetic and logic operation that can be recognized by the processor 410, data movement, or control commands such as input and output.

According to an embodiment, the processor 410 is a component capable of performing calculations for control and/or communication of each component of the electronic device 400 and data processing, and may be comprised of or associated with one or more processors 410. The processor 410 may be electrically, functionally, and/or operatively connected to each component of the electronic device 400 including the display 440, the communication module 430, and the memory 420. The processor 410 may include at least some of the elements and/or functions of the processor 120 of FIG. 1.

According to an embodiment, there is no limitation in calculations and data processing functions that can be implemented in the electronic device 400 by the processor 210 but, hereinafter, various embodiments of receiving event information related to the group SMS from an external message server and updating group SMS information, based thereon are described. The operations of the processor 410 described below may be performed as instructions stored in the memory 420 are loaded.

According to an embodiment, the processor 410 may execute a group SMS function by using a client stored in the memory 420. The electronic device 400 may download the downloadable client supporting the RCS from the application market, and install and execute the same. The processor 410 may display a user interface (UI) indicating the group SMS through the display 440.

According to an embodiment, the processor 410 may acquire a conference information object generated according to the occurrence of an event related to the group SMS from an external message server (for example, the message store server 200 of FIGS. 2 to 4 or the server device 200 of FIG. 8) through the communication module 430. According to an embodiment, the message server may generate the conference information object including information on the event that occurred in response to the occurrence of the event (for example, message transmission or a participant change) related to the group SMS. The conference information object may include at least one piece of attribute information included in a group state object and a session information object, for example, at least one of a session ID, a timestamp, a group type, participant information, topic, an icon, the maximum number of participants, and session information. The message server may store information on the event that occurred in the group SMS by using attribute information defined in the conference information object without generating the group state object and the second information object.

According to an embodiment, the processor 410 may receive a push message corresponding to the event from a push server (for example, the push server 560 of FIGS. 3A and 3B) and access the message server by using information (for example, a URL) included in the push message, so as to acquire the conference information object.

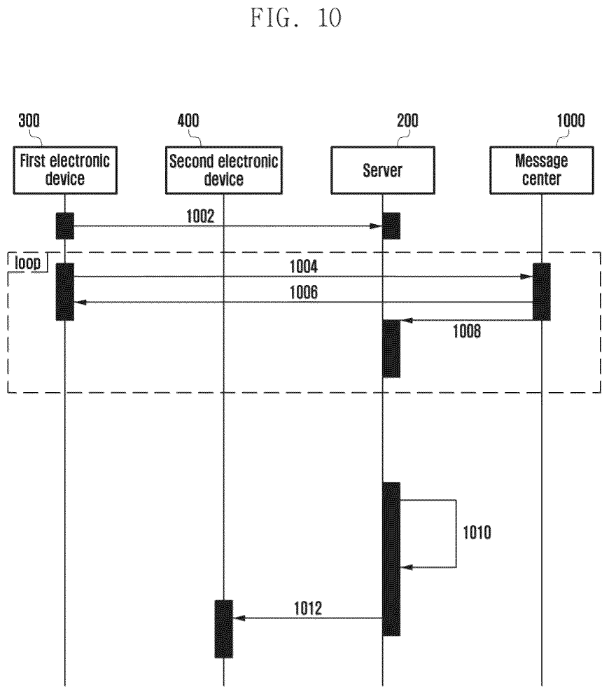

FIG. 10 illustrates an embodiment of sharing information on a group SMS between electronic devices before the group SMS is transmitted according to an embodiment.

In operation 1002, the first electronic device 300 may transmit relevant information to the server 200 before a group SMS (SMS) is transmitted. The relevant information may include information on the group SMS (SMS). The information on the group SMS (SMS) may include, for example, addresses of a plurality of recipients.

In operation 1004, the first electronic device 300 may transmit the group SMS to a message center 1000. At this time, one group SMS is displayed on the UI, but a plurality of SMSs may be individually transmitted in effect. In operation 1006, the message center 1000 may transmit a transmission result of the group SMS to the first electronic device 300.

In operation 1008, the message center 1000 may fork the plurality of SMSs to the server 200. The forking may be an operation of simultaneously transmitting a specific message or data to several destinations through one transmission request.

In operation 1010, the server 200 may identify whether the plurality of forked SMSs match the information on the group SMS (SMS) received in operation 1002. For example, the server 200 may compare addresses of the plurality of recipients and determine whether the addresses match the information on the group SMS (SMS).

The server 200 may generate an object of the group SMS, based on the information on the plurality of forked SMSs that matches the information on the group SMS (SMS) received in operation 1002. On the other hand, the server 200 may generate an object for each SMS when the information on the plurality of forked SMSs does not match the information on the group SMS (SMS) received in operation 1002.

In operation 1012, the server 200 may transmit the object of the group SMS to the second electronic device 400 or transmit the object for each SMS. When receiving the object of the group SMS, the second electronic device 400 may display a UI indicating the group SMS on the display.

When transmission of the SMS of which the transmission was requested has failed, the first electronic device 300 may make a request for transmitting the SMS to the message center 1000 again. When the SMS transmission is successful, the first electronic device 300 may make a request for transmitting the next SMS. When the SMS transmission fails, the first electronic device 300 may reattempt the SMS transmission. The server 200 may determine a message which has not been forked within a predetermined time as a message of which transmission has failed and transmit relevant information to the second electronic device 400. The second electronic device 400 may update the UI to indicate failure of transmission. The first electronic device 300 may attempt retransmission of the message of which transmission has failed and generate an object, based on transmission of all the SMSs that are successful. The server 200 may receive the object indicating that transmission of all SMSs is successful and transmit the same to the second electronic device 400. The second electronic device 400 may update the UI to indicate success of transmission, based on reception of the object.

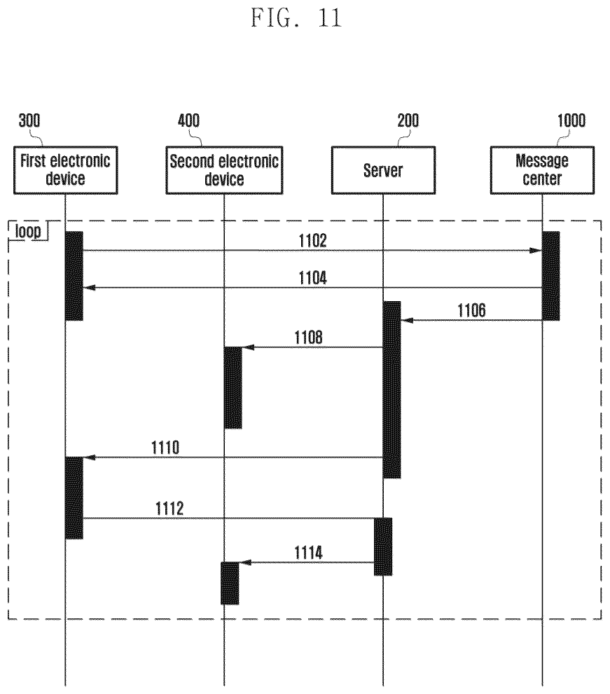

FIG. 11 illustrates an embodiment in which an electronic device updates a flag of an SMS object and shares information on a group SMS according to an embodiment.

In operation 1102, the first electronic device 300 may transmit the group SMS to the message center 1000. In operation 1104, the message center 1000 may transmit a transmission result of the group SMS to the first electronic device 300.

In operation 1106, the message center 1000 may fork the received group SMS to the server 200. The forking may be an operation of simultaneously transmitting a specific message or data to several destinations through one transmission request.

In operation 1108 and operation 1110, the server 200 may transmit a push for the forked SMS to the second electronic device 400 and the first electronic device 300.

In operation 1112, the first electronic device 300 may receive the push for the forked SMS from the server 200 and identify whether the push for the SMS is for the group SMS. The first electronic device 300 may include information indicating the group SMS in an object in the form of a flag, based on that, the push for the SMS is for the group SMS, and transmit the object to the server 200. The flag may be used to express various states of the message. The flag may be used to exchange state information of the message between the server and a client. RFC 3501 may include various flags that can express states of the message object. The first electronic device 300 may identify the state of the message by using the flag and manage the message.

In operation 1114, the server 200 may receive information indicating the group SMS from the first electronic device 300 and transmit the information indicating the group SMS to the second electronic device 400. The second electronic device 400 may update the UI to display the group SMS by using the information indicating the group SMS.

When transmission of the SMS of which the transmission was requested has failed, the first electronic device 300 may make a request for transmitting the SMS to the message center 1000 again. When the SMS transmission is successful, the first electronic device 300 may make a request for transmitting the next SMS. When the SMS transmission fails, the first electronic device 300 may reattempt the SMS transmission. The second electronic device 400 may determine a message for which a push is not received for a predetermined time as a message of which transmission has failed and update the UI to indicate failure of transmission. When receiving a flag indicating that retransmission is successful, the second electronic device 400 may update the UI to indicate success of transmission.

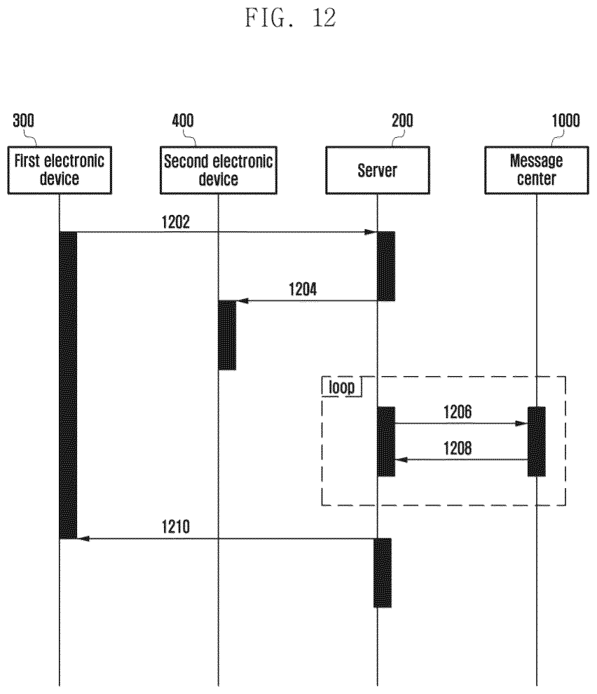

FIG. 12 illustrates an embodiment of transmitting a group SMS through an external server according to an embodiment.

In operation 1202, the first electronic device 300 may transmit an object for the group SMS to the server 200.

In operation 1204, the server 200 may transmit the received object to the second electronic device 400.

In operation 1206, the server 200 may make a request for transmitting the group SMS to the message center 1000, based on the received object. The message center 1000 may transmit an individual SMS, based on the request for transmitting the group SMS.

In operation 1208, the message center 1000 may transmit a transmission result of the individual SMS to the server 200.

In operation 1210, the server 200 may transmit the transmission result to the first electronic device 300 at a time point at which transmission of all SMSs is completed.

When transmission of the SMS of which the transmission was requested has failed, the server 200 may make a request for transmitting the SMS to the message center 1000 again. When SMS transmission is successful, the server 200 may make a request for transmitting the next SMS. When SMS transmission has failed, the server 200 may attempt the SMS transmission again. When the number of attempts to transmit the SMS exceeds a predetermined level, the server 200 may transmit information on the failed message to the first electronic device 300 and the second electronic device 400 to update the UI.

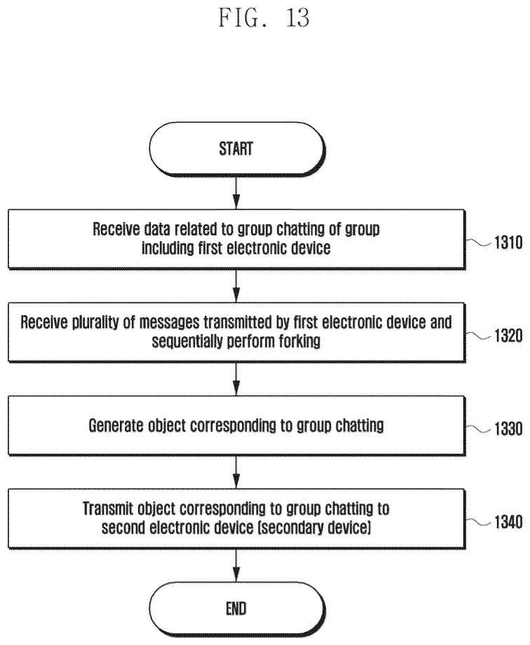

FIG. 13 is a flowchart illustrating a method by which an electronic device processes a message according to an embodiment.

Operations described through FIG. 13 may be implemented based on instructions which can be stored in a computer recording medium or a memory (for example, the memory 130 of FIG. 1). The illustrated method 1300 can be performed by the electronic device (for example, the electronic device 101 of FIG. 1) described with reference to FIGS. 1 to 12, and the technical features described above are omitted below. The order of respective operations in FIG. 13 may be changed, some operations may be omitted, and some operations may be simultaneously performed.

In operation 1310, a processor (for example, the processor 210 of FIG. 8) of a server (for example, the server 200 of FIG. 10) may receive data related to a group SMS of a group including a first electronic device (PD). According to an embodiment, the data related to the group SMS may include the content of a message input from the first electronic device (PD) and information on a plurality of addresses to which the message is to be transmitted.

In operation 1320, the processor 210 may receive a plurality of messages transmitted by the first electronic device (PD) and sequentially perform forking. The forking may be an operation of simultaneously transmitting a specific message or data to several destinations through one transmission request.

In operation 1330, the processor 210 may generate an object corresponding to the group SMS. The object may include a new form in which the group SMS can be processed. The object may be an object related to messages of a legacy message service (or xMS). The message object may include information on messages actually exchanged between clients. For example, the message object may include sender and recipient information, time information, a subject, a conversation ID, a contribution ID, a P-Asserted-service, an IMDN-message-ID, or information such as a content type.

In operation 1340, the processor 210 may transmit the object corresponding to the group SMS to a second electronic device (secondary device).

One object corresponding to the group SMS may include a plurality of messages including addresses to which the SMS is transmitted and may have the same group ID. The object corresponding to the group SMS may include or comprise information an origination address in an array form and include information on a plurality of recipients.

According to an embodiment, the processor 210 may individually generate objects for a plurality of messages transmitted by the first electronic device (PD), based on the forked message that does not match data related to the group SMS received from the first electronic device (PD) and transmit the individual object to the address configured in each message.

According to an embodiment, the processor 210 may determine a message which was not forked within a preset time as a message of which transmission has failed, and transmit information corresponding to transmission failure to the second electronic device (SD).

According to an embodiment, the processor 210 may determine the message which was not forked within a preset time as a message of which transmission has failed. The processor 210 may transmit information corresponding to transmission failure to the first electronic device (PD), make a request for transmitting again messages of which transmission from the first electronic device (PD) has failed, and generate an object corresponding to the group SMS, based on the messages transmitted from the first electronic device (PD) that are forked.

According to an embodiment, the processor 210 may transmit one object corresponding to the group SMS to the second electronic device. One object corresponding to the group SMS may include a plurality of messages including addresses to which the SMS is transmitted. One object corresponding to the group SMS may have the same group ID.

According to an embodiment, the processor 210 may receive data related to the group SMS of the group including the first electronic device. The data related to the group SMS may include the content of a message input from the first electronic device and information on a plurality of addresses to which the message is to be transmitted.

According to an embodiment, the processor 210 may individually generate objects for a plurality of messages transmitted by the first electronic device, based on the forked message that does not match the data related to the group SMS received from the first electronic device and transmit the individual object to the address configured in each message.

According to an embodiment, the object corresponding to the group SMS may include information on an origination address in an array form and include information on a plurality of recipients. The object corresponding to the group SMS may include information on an origination address in an array form, classified as a type having one group ID, and stored in the memory 130.

What is claimed is:

1. A server comprising:
communication interface;
memory storing instructions and comprising one or more storage media;
at least one processor operatively connected to the communication interface and the memory,
wherein the instructions, when individually or collectively executed by at least one processor, cause the server to:
receive data related to a group SMS of a group comprising a first electronic device;
receive a plurality of messages transmitted by the first electronic device from a SMS message center (SMSC);
perform forking on the plurality of messages sequentially;
generate an object corresponding to the group SMS based on address information of forked messages that match the data related to the group SMS received from the first electronic device; and
transmit the object corresponding to the group SMS to a second electronic device.

2. The server of claim 1, wherein the instructions, when individually or collectively executed by at least one processor, further cause the server to:
transmit another object corresponding to the group SMS to the second electronic device, wherein the another object comprises one or more messages including addresses to which a SMS is transmitted, and wherein the another object has a group ID.

3. The server of claim 1, wherein the data related to the group SMS comprises content of a message input from the first electronic device and information on a plurality of addresses to which the message is to be transmitted.

4. The server of claim 1, wherein the instructions, when individually or collectively executed by at least one processor, further cause the server to:
generate respective objects for each of the plurality of messages transmitted by the first electronic device based on the forked messages that do not match the data related to the group SMS received from the first electronic device; and
transmit the respective objects to addresses configured in respective messages.

5. The server of claim 1, wherein the instructions, when individually or collectively executed by at least one processor, further cause the server to:
determine a message which is not forked within a preconfigured time as a message for which transmission has failed; and
transmit information corresponding to transmission failure of the message for which transmission has failed to the second electronic device.

6. The server of claim 1, wherein the instructions, when individually or collectively executed by at least one processor, further cause the server to:
determine a message which is not forked within a preconfigured time as a message for which transmission has failed;
transmit information corresponding to transmission failure of the message for which transmission has failed to the first electronic device;
request retransmission of the message for which transmission has failed; and
generating the object corresponding to the group SMS based on messages that are forked and transmitted by the first electronic device.

7. The server of claim 1, wherein the object corresponding to the group SMS comprises information on an origination address in an array form and information on a plurality of recipients.

8. The server of claim 1, wherein the object corresponding to the group SMS comprises information on an origination address in an array form, wherein the object corresponding to the group SMS is classified as a type having one group ID, and wherein the object corresponding to the group SMS is stored in the memory.

9. A server comprising:
communication interface;
memory storing instructions and comprising one or more storage media; and
at least one processor operatively connected to the communication interface and the memory,
wherein the instructions, when individually or collectively executed by at least one processor, cause the server to:
receive data related to a group SMS of a group comprising a first electronic device;
receive a plurality of messages transmitted by the first electronic device from a SMS message center (SMSC);
sequentially perform forking on the plurality of messages;
transmit a first notification for forked messages to the first electronic device; and
transmit a second notification for the group SMS to a second electronic device based on information indicating that the forked messages are included in the group SMS is received from the first electronic device.

10. The server of claim 9, wherein the information indicating that the forked messages are included in the group SMS comprises:
an ID of the group SMS,
content of messages, and
information on a plurality of addresses to which the messages are to be transmitted.

11. The server of claim 9, wherein the second notification comprises an object corresponding to the group SMS comprises information on an origination address in an array form and information on a plurality of recipients.

12. The server of claim 9, wherein the second notification comprises an object corresponding to the group SMS comprises information on an origination address in an array form, wherein the object corresponding to the group SMS is classified as a type having one group ID, and wherein the object corresponding to the group SMS is stored in the memory.

13. A method of operating a server, the method comprising:
receiving data related to a group SMS of a group comprising a first electronic device;
receiving a plurality of messages transmitted by the first electronic device from a SMS message center (SMSC);
sequentially performing forking on the plurality of messages;
generating a first object corresponding to the group SMS based on address information of forked messages that matches the data related to the group SMS received from the first electronic device; and
transmitting the first object corresponding to the group SMS to a second electronic device.

14. The method of claim 13, further comprising transmitting a second object corresponding to the group SMS to the second electronic device,
wherein the second object corresponding to the group SMS comprises one or more messages including addresses to which a SMS is transmitted, and
wherein the second object has a group ID.

15. The method of claim 13, wherein the data related to the group SMS comprises content of a message input from the first electronic device and information on a plurality of addresses to which the message is to be transmitted.

16. The method of claim 13, further comprising:
generating respective objects for each of the plurality of messages transmitted by the first electronic device based on the forked messages that do not match the data related to the group SMS received from the first electronic device; and
transmitting the respective objects to addresses configured in respective messages.

17. The method of claim 13, further comprising:
determining a message which is not forked within a preconfigured time as a message for which transmission has failed has failed; and
transmitting information corresponding to transmission failure of the message for which transmission has failed to the second electronic device.

18. The method of claim 13, further comprising:
determining a message which is not forked within a preconfigured time as a message for which transmission has failed;
transmitting information corresponding to transmission failure of the message for which transmission has failed to the first electronic device;
requesting retransmission for messages for which transmission by the first electronic device has failed; and
generating the first object corresponding to the group SMS based on messages that are forked and transmitted by the first electronic device.

19. The method of claim 13, wherein the first object corresponding to the group SMS comprises information on an origination address in an array form and information on a plurality of recipients.

20. The method of claim 13, wherein the first object corresponding to the group SMS comprises information on an origination address in an array form, wherein the first object corresponding to the group SMS is classified as a type having one group ID, and wherein the first object corresponding to the group SMS is stored in a memory.
